(19) United States
(12) Patent Application Publication
(10) Pub. No.: US 2013/0138536 A1
(43) Pub. Date: May 30, 2013

(54) LOGISTICS SUPPORT METHOD AND SYSTEM FOR ONLINE SHOPPING

(71) Applicants: Bong-Koon KOH, Goyang-si (KR); Sang-Jae Lee, Seoul (KR); Sa-Eun Park, Seoul (KR); Jae-Woo Park, Guri-si (KR); Ki-Hoon Cha, Seoul (KR); Do-Hyun Kim, Namyangju-si (KR); Mi-Yeon Kang, Seoul (KR); Soon-Chol Kwon, Seoul (KR)

(72) Inventors: Bong-Koon KOH, Goyang-si (KR); Sang-Jae Lee, Seoul (KR); Sa-Eun Park, Seoul (KR); Jae-Woo Park, Guri-si (KR); Ki-Hoon Cha, Seoul (KR); Do-Hyun Kim, Namyangju-si (KR); Mi-Yeon Kang, Seoul (KR); Soon-Chol Kwon, Seoul (KR)

(73) Assignee: I-CIUS CO., LTD., Seoul (KR)

(21) Appl. No.: 13/552,765

(22) Filed: Jul. 19, 2012

(30) Foreign Application Priority Data
Nov. 28, 2011 (KR) 10-2011-0125348

(51) Int. Cl. G06Q 30/06

(52) U.S. Cl. 705/26.81

(57) ABSTRACT

A logistics support method of a logistics support system for supporting online shopping includes: receiving a usable range for a waybill number from at least one delivery service company system; receiving product order information, except for personal information, from a sales company server selling a product; receiving a request for waybill output information containing the product order information from a supply company system supplying the product or the delivery service company system delivering the product; receiving and encrypting the personal information corresponding to the product order information from the sales company server; generating the waybill output information containing the encrypted personal information, the product order information, and a waybill number belong to the usable waybill number range; and transmitting the waybill output information to the supply company system or the delivery service company system.

### CROSS-REFERENCE TO RELATED APPLICATION

This application claims priority to and the benefit of Korean Patent Application No. 10-2011-0125348 filed in the Korean Intellectual Property Office on Nov. 28, 2011, the entire contents of which are incorporated herein by reference.

### BACKGROUND OF THE INVENTION

(a) Field of the Invention

The present invention relates to a logistics support method and system for online shopping.

(b) Description of the Related Art

Recently, an online shopping market has rapidly grown. In this respect, a manufacturing company or a vendor supplying products desires to sell product by using various online shopping, such as Internet shopping or home shopping.

According to a schematic procedure of the online shopping, when a purchaser places an order for a product through a server of a sales company of the product, the sales company of the product may release itself and directly deliver the product or deliver the product through a delivery service company, or a supply company of the product may deliver the product through a delivery service company when the sales company of the product transfers order information to a system of the supplier.

In this case, in order to deliver the product to the purchaser and/or the receiver of the product, the sales company is required to provide the delivery service company or the supply company with personal information regarding the purchaser and/or the receiver of the product. Accordingly, a risk that the personal information about the purchaser will be leaked is increased. It is necessary for the sales company of the online shopping to securely prevent the personal information on the purchaser from being leaked to the outside.

Accordingly, a method of effectively supporting a logistics operation while reducing the risk of leaking the personal information is necessary.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a logistics support method and system having advantages of protecting personal information on a user using online shopping while minimizing an influence exerted on a logistics flow.

An exemplary embodiment of the present invention provides a logistics support method of a logistics support system for supporting online shopping, including: receiving a usable range for a waybill(or an invoice) number from at least one delivery service company system; receiving product order information, except for personal information, from a sales company server selling a product; receiving a request for waybill output information containing the product order information from a supply company system supplying the product or the delivery service company system delivering the product; receiving and encrypting the personal information corresponding to the product order information from the sales company server; generating the waybill output information containing the encrypted personal information, the product order information, and waybill numbers belong to the usable waybill number range; and transmitting the waybill output information to the supply company system or the delivery service company system.

The logistics support system may be connected with at least one of the sales company server, the supply company system, and the delivery service company system through an Electronic Data Interchange (EDI) interface.

The encrypted personal information may be decoded and outputted in the supply company system or the delivery service company system.

The encrypted personal information may be at least one of a name, a telephone number, an address, an email address, a resident registration number, and a birthdate.

The logistics support method may further include transmitting a waybill number included in the waybill output information to the sales company server.

The logistics support method may further include receiving product recovery information, except for the personal information, from the sales company server; receiving a request for waybill output information for recovery containing product recovery information from the delivery service company system delivering the product; receiving and encrypting the personal information corresponding to the product recovery information from the sales company server; generating the waybill output information for recovery containing the encrypted personal information, the product recovery information, and waybill numbers belong to the usable waybill number range; and transmitting the waybill output information for recovery to the delivery service company system.

The logistics support method may further include: receiving product recovery information, except for the personal information from the sales company server; receiving a request for the personal information corresponding to the product recovery information from the delivery service company system delivering the product; receiving and encrypting the personal information corresponding to the product recovery information from the sales company server; and transmitting the encrypted personal information to the delivery service company system.

The logistics support method may further include: receiving complaint reception information of the purchaser of the product from the sales company server; and transmitting the complaint reception information to the supply company system or the delivery service company system.

Another exemplary embodiment of the present invention provides a logistics support system for supporting online shopping, including: an information management module for storing and managing a usable range for a waybill number received from at least one delivery service company system and product order information received from at least one sales company server; a security management module for encrypting personal information received from the sales company server; and a waybill output management module for, when a request for waybill output is received from the delivery service company system or a supply company system supplying the product, generating waybill output information using the encrypted personal information, the product order information, and a waybill number belong to the usable waybill number range, and providing the waybill output information to the delivery service company system or the supply company system.

The security management module may be implemented by an Electronic Data Interchange (EDI) server installed in the logistics support system and an EDI client installed in the sales company server.

When the EDI server makes a request for the personal information to the EDI client, the EDI client may encrypt the personal information received from the sales company server and transfer the encrypted personal information to the EDI server.

The personal information on the purchaser or the recipient of the product is encrypted and transferred to the supply company or the delivery service company from the sales company, so that it is possible to greatly reduce a possibility that the personal information will be leaked. Further, it is possible to simplify logistics operations between the sales company, the supply company, and the delivery service company of the product. Accordingly, the online shopping market may be further activated.

### BRIEF DESCRIPTION OF THE DRAWINGS

FIG. 1 is a diagram illustrating a service environment of a logistics support system for online shopping according to an exemplary embodiment of the present invention.

FIG. 2 is a block diagram illustrating an internal structure of a logistics support system 300 according to an exemplary embodiment of the present invention.

FIG. 3 is a flowchart illustrating a logistics support method of a logistics support system according to an exemplary embodiment of the present invention.

FIG. 4 is a flowchart illustrating a logistics support method of a logistics support system according to another exemplary embodiment of the present invention.

FIGS. 5 and 6 are flowcharts illustrating a logistics support method of a logistics support system according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising”, will be understood to imply the inclusion of stated elements but not the exclusion of any other elements.

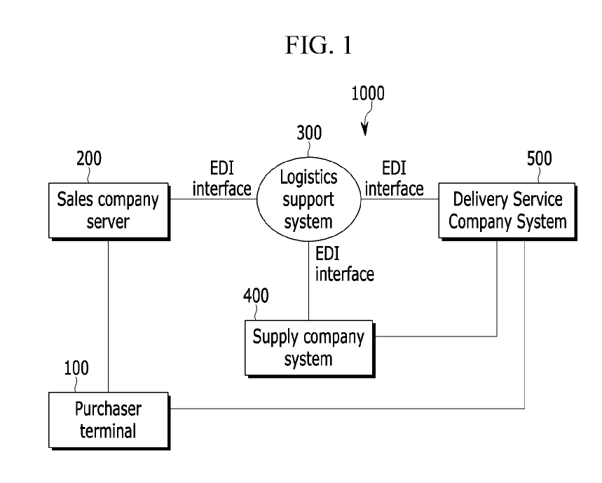

In the present specification, online shopping means an action of purchasing a product by a purchaser through online. For example, the online shopping may be Internet shopping in which a purchaser visits a shopping mall established on the internet and purchases a product by using a computer or home shopping in which a purchaser purchases a product by using a home shopping broadcasting. The online shopping may be called Internet shopping, home shopping, cyber shopping, electronic shopping, open mall, electronic commerce, etc. FIG. 1 is a diagram illustrating a service environment of a logistics support system for online shopping according to an exemplary embodiment of the present invention.

Referring to FIG. 1, the service environment 1000 of the logistics support system includes a purchaser terminal 100, a sales company server 200, a logistics support system 300, a supply company system 400, and a delivery service company system 500.

The purchaser terminal 100, which is a terminal of a purchaser who purchases a product through the online shopping, may be a Personal Computer (PC), a telephone, a mobile terminal, etc.

The sales company server 200 may be a server of a home shopping company selling products or a server of an Internet shopping mall. The logistics support system 300 receives product order information input through the purchaser terminal 100 from the sales company server 200 and transfers the product order information to the supply company system 400 or the delivery service company system 500. The logistics support system 300 supports a general procedure for distribution of the product, which will be described in detail later.

The supply company system 400 means a manufacturing company system or a vendor system supplying the product. In the present specification, the supply company system 400 may designate a terminal used in the supply company, as well as a server operated by the supply company.

The delivery service company system 500 means a system of a delivery service company which delivers a product to a purchaser. The delivery service company system 500 may designate a terminal used in the delivery service company, as well as a server operated by the delivery service company.

When the purchaser terminal 100 accesses the sales company server 200 and places an order for a product, the sales company server 200 may release the product itself, make the product to be delivered through the delivery service company system 500, or make the product to be delivered through the supply company system 400. When the sales company server 200 makes the product to be delivered through the supply company system 400, the supply company system 400 may directly deliver the product or make the product to be delivered through the delivery service company system 500. For this purpose, it is required to transfer delivery information containing personal information on the purchaser(the sender) and/or the recipient(the receiver) to the supply company system 400 or the delivery service company system 500. In this specification, the personal information means personal information on at least one of a purchaser, a sender and a recipient.

As described above, when the product is delivered through the supply company system 400 or the delivery service company system 500, a risk that the personal information on the purchaser and/or the receiver will be leaked is increased. Accordingly, the logistics support system 300 relays the sales company server 200, the supply company system 400, and the delivery service company system 500, so that the risk of the personal information leakage may be minimized.

The logistics support system 300 may be connected with the sales company server 200, the delivery service company system 500, and the supply company system 400 through an Electronic Data Interchange (EDI) interface. The EDI means a standard of data and documents designated for efficiently exchanging data between companies.

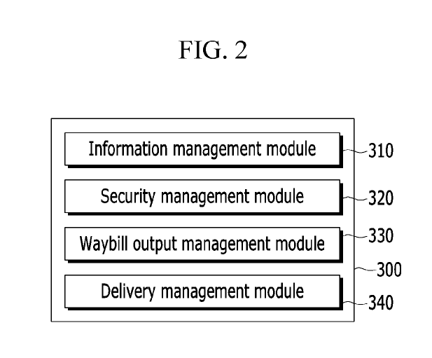

FIG. 2 is a block diagram illustrating an internal structure of the logistics support system 300 according to an exemplary embodiment of the present invention.

Referring to FIG. 2, the logistics support system 300 includes an information management module 310, a security management module 320, a waybill output management module 330, and a delivery management module 340.

The information management module 310 may store and manage the product order information, product recovery information, complaint reception information, etc. received from the sales company server 200. Further, the information management module 310 may store and manage product stock information, product release information, etc. received from the supply company system 400. Further, the information management module 310 may store and manage usable range information for a waybill number, product delivery information, etc. received from the delivery service company system 500.

The security management module 320 provides the supply company system 400 or the delivery service company system 500 with encrypted personal information. For this purpose, the security management module 320 may be implemented with an EDI client connected to an EDI server and the sales company server 200. The EDI client may be installed within the sales company server 200. That is, when the logistics support system 300 receives a request for output of the waybill from the supply company system 400 or the delivery service company system 500, the EDI server of the logistics support system 300 may make a request for the personal information on the purchaser and/or the receiver to the EDI client connected to the sales company server 200. The EDI client may encrypt the personal information received from the sales company server 200 and transmit the encrypted personal information to the EDI server.

When the waybill output management module 330 receives the request for output of the waybill from the supply company system 400 or the delivery service company system 500, the waybill output management module 330 may generate waybill output information necessary for the output of the waybill and transmit the generated waybill output information to the supply company system 400 or the delivery service company system 500. That is, the waybill output management module 330 may generate the waybill output information by using the product order information or the product recovery information and the waybill number range information stored in the information management module 310 and the encrypted personal information received from the security management module 320. Further, a decoding function may be further included such that the encrypted personal information is decoded and outputted through an output device connected to the supply company system 400 or the delivery service company system 500. Accordingly, the logistics support system 300 transmits the waybill output information containing the encrypted personal information to the supply company system 400 or the delivery service company system 500, and the supply company system 400 or the delivery service company system 500 decodes and outputs the encrypted personal information, thereby being capable of preventing the bulk leakage of the personal information.

The delivery management module 340 may store and manage product delivery-related information received from the supply company system 400 or the delivery service company system 500 and notify the sales company server 200 of the product delivery-related information.

Hereinafter, a logistics support method of the logistics support system 300 in a case where the sales company server 200 delivers the product through the supply company system 400 will be described in detail.

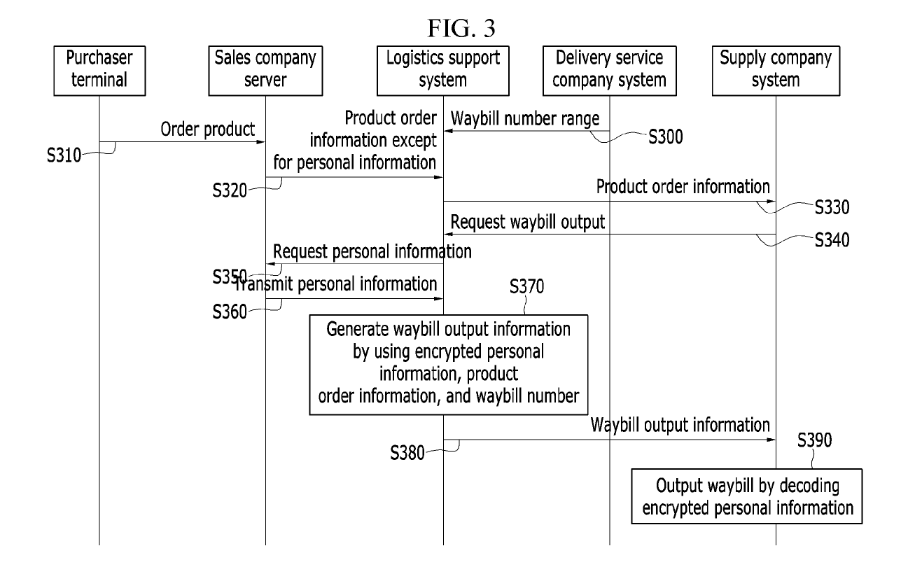

FIG. 3 is a flowchart illustrating a logistics support method of a logistics support system according to an exemplary embodiment of the present invention.

Referring to FIG. 3, the logistics support system 300 receives a usable range for a waybill number from at least one delivery service company system 500 (S300). The usable waybill number range may include at least one waybill number. The logistics support system 300 may store a pre-arranged waybill number range in the information management module 310 for each delivery service company.

In the meantime, when the purchaser terminal 100 accesses the sales company server 200 and places an order for a product (S310), the sales company server 200 transmits product order information, except for personal information on a purchaser and/or a receiver, to the logistics support system 300 (S320). For example, the product order information may be at least one among a product name, the number of products, and a date of the order. The logistics support system 300 may store the product order information received from the sales company server 200 in a DB.

When the logistics support system 300 transfers the product order information received from the sales company server 200 to the supply company system 400 (S330), the supply company system 400 makes a request for output of the waybill to the logistics support system 300 (S340). For this purpose, the supply company system 400 may confirm the product order information by accessing a web page of the logistics support system 300, check stock, and then make the request for the output of the waybill through a web page of the logistics support system 300.

Accordingly, the logistics support system 300 makes a request for personal information corresponding to the product order information to the sales company server 200 (S350), and the sales company server 200 transmits the personal information to the logistics support system 300 (S360). Here, the personal information may be at least one among a name, a telephone number, an address, an email address, a resident registration number, and a birthdate of the purchaser and/or the receiver. Although it is not illustrated, the sales company server 200 may be connected with the EDI client of the logistics support system 300, and the personal information provided by the sales company server 200 may be encrypted in the EDI client.

The logistics support system 300 generates waybill output information by collecting the encrypted personal information, the product order information, and the waybill number (S370). Here, the waybill number may be one of the waybill numbers belong to the usable waybill number range pre-acquired from the delivery service company system 500 in step S300. When the logistics support system 300 receives the request for the output of the waybill from the supply company system 400, the logistics support system 300 may allocate the waybill number out of the usable waybill number range pre-acquired from the delivery service company system 500 to the product order information received from the sales company server 200.

The logistics support system 300 transmits the generated waybill output information to the supply company system 400 (S380), and the supply company system 400 outputs the waybill by decoding the encrypted personal information (S390). For example, when the supply company system 400 makes the request for the output of the waybill through the web page of the logistics support system 300 in step S340, the logistics support system 300 may transfer the waybill output information containing the encrypted personal information, the product order information, and the waybill number to a decoding module executed in a corresponding web browser and the decoded information may be transmitted to an output device connected to the supply company system 400. For another example, a decoding module may be mounted in an output device connected to the supply company system 400. Here, the output device of the supply company system 400 may be a printer, a PC monitor, or a screen of a portable terminal. The encrypted personal information transmitted to the supply company system 400 may be discarded such that the encrypted personal information cannot be restored to its original state in a memory.

Then, the logistics support system 300 may transmit the waybill number to the sales company server 200. Accordingly, when the purchaser terminal 100 makes an inquiry about delivery information by accessing the sales company server 200, the sales company server 200 may display the delivery information indicating that the corresponding product is being delivered.

Hereinafter, a logistics support method of the logistics support system 300 in a case where the sales company server 200 makes the delivery service company system 500 to deliver the product without passing through the supply company system 400 will be described in detail. Description repeated in the description in relation to FIG. 3 will be omitted.

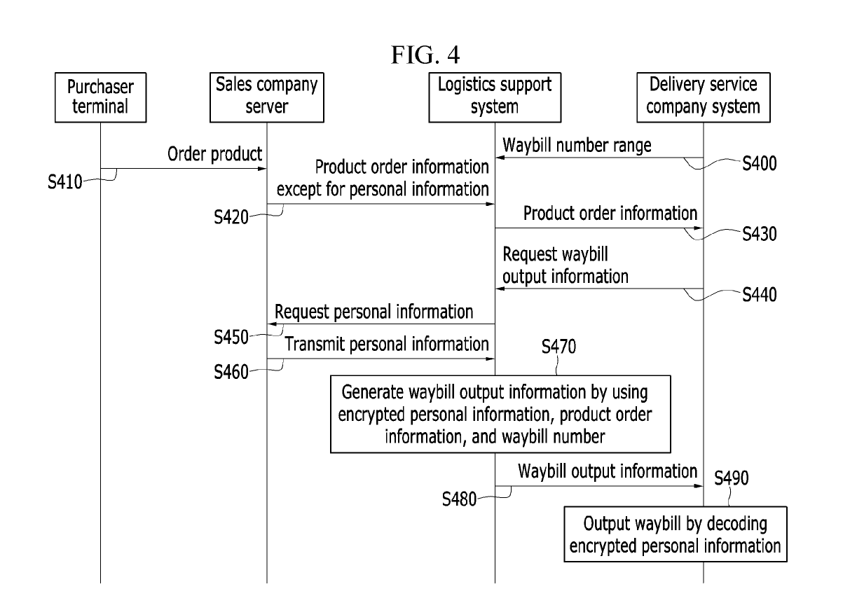

FIG. 4 is a flowchart illustrating a logistics support method of the logistics support system according to another exemplary embodiment of the present invention.

Referring to FIG. 4, the logistics support system 300 receives a usable range for a waybill number from at least one delivery service company system 500 (S400).

In the meantime, when the purchaser terminal 100 accesses the sales company server 200 and places an order for a product (S410), the sales company server 200 transmits product order information, except for personal information on a purchaser and/or a receiver, to the logistics support system 300 (S420).

When the logistics support system 300 transfers the order product information received from the sales company server 200 to the delivery service company system 500 (S430), the delivery service company system 500 makes a request for output of the waybill to the logistics support system 300 (S440). For this purpose, the delivery service company system 500 may confirm the product order information by accessing a web page of the logistics support system 300 and then make the request for the output of the waybill through a web page of the logistics support system 300.

Accordingly, the logistics support system 300 makes a request for personal information corresponding to the product order information to the sales company server 200 (S450), and the sales company server 200 transmits the personal information to the logistics support system 300 (S460). Here, the personal information may be at least one among a name, a telephone number, an address, an email address, a resident registration number, and a birthdate of the purchaser and/or the receiver of the product. Although it is not illustrated, the sales company server 200 may be connected with the EDI client of the logistics support system 300, and the personal information provided by the sales company server 200 may be encrypted in the EDI client.

The logistics support system 300 generates waybill output information by collecting encrypted personal information, the product order information, and the waybill number (S470). Here, the waybill number may be one of waybill numbers belong to the usable waybill number range pre-acquired from the delivery service company system 500 in step S400. When the logistics support system 300 receives the request for the output of the waybill from the delivery service company system 500, the logistics support system 300 may allocate the waybill number out of the usable waybill number range pre-acquired from the delivery service company system 500 to the product order information received from the sales company server 200.

The logistics support system 300 transmits the generated waybill output information to the delivery service company system 500 (S480), and the delivery service company system 500 outputs the waybill by decoding the encrypted personal information (S490). For example, when the delivery service company system 500 makes the request for the output of the waybill through the web page of the logistics support system 300 in step S440, the logistics support system 300 may transfer the waybill output information containing the encrypted personal information, the product order information, and the waybill number to a decoding module executed in a corresponding web browser and the decoded information may be transmitted to an output device connected to the delivery service company system 500. For another example, a decoding module may be mounted in an output device connected to the delivery service company system 500. Here, the output device of the delivery service company system 500 may be a printer, a PC monitor, or a screen of a portable terminal. The encrypted personal information transmitted to the delivery service company system 500 may be discarded such that the encrypted personal information cannot be restored to its original state in a memory.

In the meantime, after the product is delivered to the purchaser and/or the receiver, the purchaser and/or the receiver may desire to return or exchange the product. For this purpose, the purchaser and/or the receiver may make a request for product recovery to the sales company server 200 through the purchaser terminal 100. Hereinafter, a logistics support method in recovering the product will be described in detail. The recovering the product means withdrawing the product.

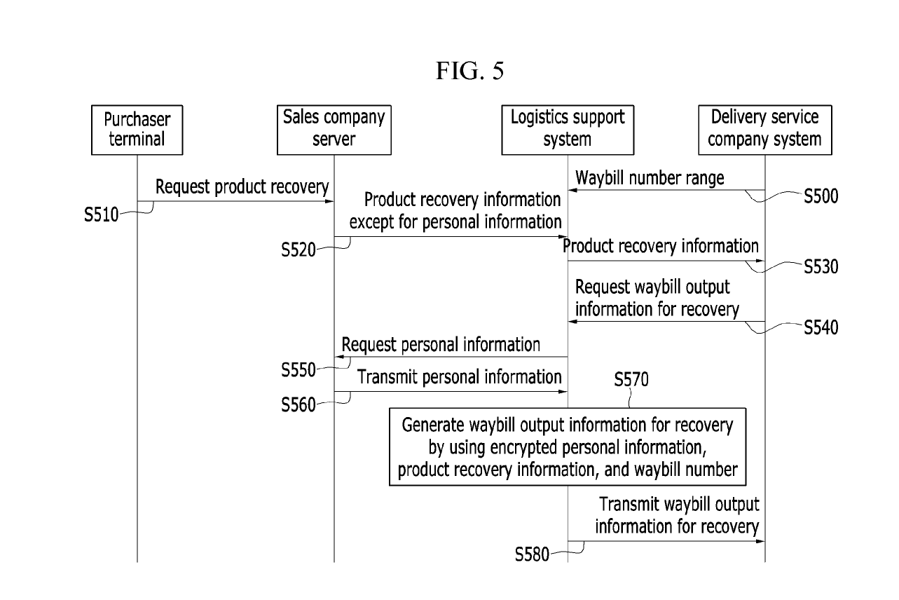

FIG. 5 is a flowchart illustrating a logistics support method of a logistics support system according to another exemplary embodiment of the present invention.

Referring to FIG. 5, the logistics support system 300 receives a usable range for a waybill number from at least one delivery service company system 500 (S500). The usable range for a waybill number may include at least one waybill number. For example, the logistics support system 300 may periodically receive the waybill number range from at least one delivery service company system 500. For another example, when the predetermined number or less of waybill numbers allocatable for the product delivery or the product recovery is left, the logistics support system 300 may make a request for the waybill number range to the delivery service company system 500.

In the meantime, when the purchaser terminal 100 accesses the sales company server 200 and makes a request for the recovery of a product (S510), the sales company server 200 transmits product recovery information, except for personal information on a purchaser and/or a receiver, to the logistics support system 300 (S520). When the purchaser and/or the receiver desires to exchange or return the product, the purchaser terminal 100 may make the request for the recovery of the product. For example, the product recovery information may be at least one among a product name, the number of products, and a date of the recovery request.

When the logistics support system 300 transfers the product recovery information received from the sales company server 200 to the delivery service company system 500 (S530), the delivery service company system 500 notifies the sales branch office of a delivery service company which will collect the product corresponding to the product recovery information (not shown).

When the sales branch office of the delivery service company accesses the delivery service company system 500 and makes a request for output of the waybill, the delivery service company system 500 makes the request for the output of the waybill to the logistics support system 300 by accessing the logistics support system 300 (S540).

Accordingly, the logistics support system 300 makes a request for personal information corresponding to the product recovery information to the sales company server 200 (S550), and the sales company server 200 transmits the personal information to the logistics support system 300 (S560). Although it is not illustrated, the sales company server 200 may be connected with the EDI client of the logistics support system 300, and the personal information provided by the sales company server 200 may be encrypted in the EDI client.

The logistics support system 300 generates waybill output information by collecting the encrypted personal information, the product recovery information, and the waybill number (S570). Here, the waybill number may be one of waybill numbers belong to the usable waybill number range pre-acquired from the delivery service company system 500 in step S500. When the logistics support system 300 receives the request for the output of the waybill from the delivery service company system 500, the logistics support system 300 may allocate the waybill number pre-acquired from the delivery service company system 500 to the product recovery information received from the sales company server 200.

The logistics support system 300 transmits the generated waybill output information to the delivery service company system 500 (S580), and the delivery service company system 500 or the sales branch office outputs the waybill by decoding the encrypted personal information (S590).

Then, the logistics support system 300 may transmit the waybill number to the sales company server 200.

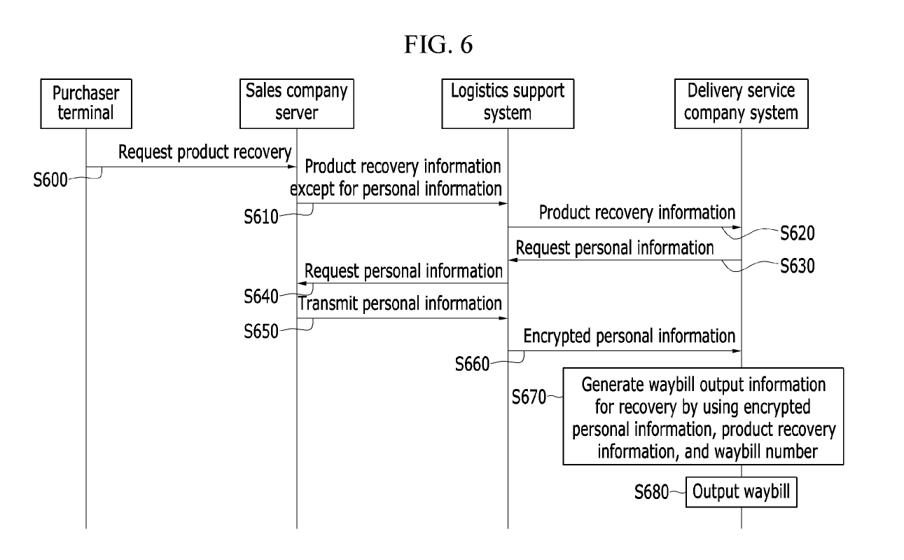

FIG. 6 is a flowchart illustrating a logistics support method of the logistics support system according to another exemplary embodiment of the present invention.

Referring to FIG. 6, when the purchaser terminal 100 accesses the sales company server 200 and makes a request for the recovery of a product (S600), the sales company server 200 transmits product recovery information, except for personal information on a purchaser and/or a receiver, to the logistics support system 300 (S610). When the purchaser and/or the receiver of the product desires to exchange or return the product, the purchaser terminal 100 may make the request for the recovery of the product. For example, the product recovery information may be at least one among a product name, the number of products, and a date of the recovery request.

When the logistics support system 300 transfers the product recovery information received from the sales company server 200 to the delivery service company system 500 (S620), the delivery service company system 500 notifies the sales branch office of a delivery service company to collect the product corresponding to the product recovery information (not shown).

When the sales branch office of the delivery service company desires to output the waybill, the delivery service company system 500 makes a request for personal information on a sender corresponding to the product recovery information by accessing the logistics support system 300 (S630).

Accordingly, the logistics support system 300 makes a request for the personal information corresponding to the product recovery information to the sales company server 200 (S640), and the sales company server 200 transmits the personal information to the logistics support system 300 (S650). Although it is not illustrated, the sales company server 200 may be connected with the EDI client of the logistics support system 300, and the personal information provided by the sales company server 200 may be encrypted in the EDI client.

The logistics support system 300 transmits the encrypted personal information to the delivery service company system 500 (S660). The delivery service company system 500 generates waybill output information by collecting the encrypted personal information, the product recovery information, and the waybill number (S670), and outputs the waybill by decoding the encrypted personal information (S680).

Although it is not illustrated, when a complaint is received from the purchaser, it may be processed in a similar manner to that of the recovery procedure.

That is, when the delivery for the purchaser is delayed, the purchaser terminal 100 may make a complaint by accessing the sales company server 200. For example, the making of the complaint is to make a complaint against the supply company before the delivery service company actually picks up the product after a supply company outputs the waybill, and the making of the complaint is to make a complaint against the delivery service company before the delivery service company delivers the product to the purchaser after the delivery service company picks up the product.

When the complaint is received from the purchaser terminal 100, the sales company server 200 transmits complaint information, except for personal information, to the logistics support system 300. Here, the complaint information may include at least one among a name of the product, the number of products, a date of the product order, the waybill number, and information on the supply company making a release delay or information on the delivery service company making a delivery delay.

When the logistics support system 300 transmits the complaint information to the supply company system 400 or the delivery service company system 500, the supply company system 400 or the delivery service company system 500 may make a request for the personal information for handling the complaint.

Accordingly, the logistics support system 300 may make the request for the personal information for the corresponding complaint to the sales company server 200, and the sales company server 200 may transmit encrypted personal information to the logistics support system 300 through the EDI client. Then, the logistics support system 300 may decode the encrypted personal information and complaint information and output the decoded personal information and complaint information on a screen of the supply company system 400 or the delivery service company system 500.

As described above, the logistics support system 300 receives the encrypted personal information through the EDI client connected to the sales company server 200 in the delivery of the product, the recovery of the product, and the handling of the complaint and transmits the received encrypted personal information to the supply company system 400 or the delivery service company system 500, so that it is possible to prevent the bulk leakage of the personal information.

The above-mentioned exemplary embodiments of the present invention are not embodied only by an apparatus and method. Alternatively, the above-mentioned exemplary embodiments may be embodied by a program performing functions, which correspond to the configuration of the exemplary embodiments of the present invention, or a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A logistics support method of a logistics support system for supporting online shopping, comprising:
receiving a usable range for a waybill number from at least one delivery service company system;
receiving product order information, except for personal information, from a sales company server selling a product;
receiving a request for waybill output information containing the product order information from a supply company system supplying the product or the delivery service company system delivering the product;
receiving and encrypting the personal information corresponding to the product order information from the sales company server;
generating the waybill output information containing the encrypted personal information, the product order information, and a waybill number belong to the usable waybill number range; and
transmitting the waybill output information to the supply company system or the delivery service company system.

2. The logistics support method of claim 1, wherein:
the logistics support system is connected with at least one of the sales company server, the supply company system, and the delivery service company system through an Electronic Data Interchange (EDI) interface.

3. The logistics support method of claim 1, wherein:
the encrypted personal information is decoded and outputted in the supply company system or the delivery service company system.

4. The logistics support method of claim 1, wherein:
the encrypted personal information is at least one of a name, a telephone number, an address, an email address, a resident registration number, and a birthdate.

5. The logistics support method of claim 1, further comprising:
transmitting the waybill number included in the waybill output information to the sales company server.

6. The logistics support method of claim 5, further comprising:
receiving product recovery information, except for the personal information on a purchaser and/or a receiver of the product, from the sales company server;
receiving a request for waybill output information for the recovery containing product recovery information from the delivery service company system delivering the product;
receiving and encrypting the personal information corresponding to the product recovery information from the sales company server;
generating the waybill output information for recovery containing the encrypted personal information, the product recovery information, and a waybill number belong to the usable waybill number range; and
transmitting the waybill output information for the recovery to the delivery service company system.

7. The logistics support method of claim 5, further comprising:
receiving product recovery information, except for the personal information on a purchaser and/or a receiver of the product from the sales company server;
receiving a request for the personal information corresponding to the product recovery information from the delivery service company system delivering the product;
receiving and encrypting the personal information corresponding to the product recovery information from the sales company server; and
transmitting the encrypted personal information to the delivery service company system.

8. The logistics support method of claim 5, comprising:
receiving complaint reception information of the purchaser of the product from the sales company server; and
transmitting the complaint reception information to the supply company system or the delivery service company system.

9. A logistics support system for supporting online shopping, comprising:
an information management module for storing and managing a usable range for a waybill number received from at least one delivery service company system and product order information received from at least one sales company server;
a security management module for encrypting personal information received from the sales company server; and
a waybill output management module for, when a request for waybill output is received from the delivery service company system or a supply company system supplying the product, generating waybill output information using the encrypted personal information, the product order information, and a waybill number belong to the usable waybill number range, and providing the waybill output information to the delivery service company system or the supply company system.

10. The logistics support system of claim 9, wherein:
the security management module is implemented by an Electronic Data Interchange (EDI) server installed in the logistics support system and an EDI client installed in the sales company server.

11. The logistics support system of claim 10, wherein:
when the EDI server makes a request for the personal information to the EDI client, the EDI client encrypts the personal information received from the sales company server and transfers the encrypted personal information to the EDI server.
